(19) United States
(12) Patent Application Publication
(10) Pub. No.: US 2024/0207981 A1
(43) Pub. Date: Jun. 27, 2024

(54) TITANIUM DEPOSITION WIRE OF THE POWDER-IN-TUBE TYPE

(71) Applicants: NV Bekaert SA, Zwevegem (BE); EPOCH WIRES LIMITED, Cambridge (GB)

(72) Inventors: Jan MESTDAGH, Harelbeke (BE); Matthias GOUWY, Sint-Jans-Molenbeek (BE); Chris DHULST, Oeselgem (BE); Serdar ATAMERT, Cambridge (GB)

(73) Assignees: NV Bekaert SA, Zwevegem, BE (BE); EPOCH WIRES LIMITED, Cambridge (GB)

(21) Appl. No.: 18/289,060

(22) PCT Filed: Apr. 28, 2022
(86) PCT No.: PCT/EP2022/061295

§ 371 Date: Oct. 31, 2023

(30) Foreign Application Priority Data
May 3, 2021 (EP) 21250003.7

(51) Int. Cl. B23K 35/40; B22F 7/04; C22C 1/04

(52) U.S. Cl. CPC B23K 35/406; B22F 7/04; C22C 1/0458; B22F 2301/205

(57) ABSTRACT

A deposition wire of the powder-in-tube type comprises a hollow tubular portion of titanium and a core portion filling the tubular portion. The core portion occupies between (30) volume % and (80) volume % of the deposition wire. The core portion comprises compacted elongated powders of titanium and possibly also comprises other compacted powders selected from the group consisting of aluminium, vanadium, aluminium-vanadium, chromium, molybdenum, boron, niobium, tantalum, nickel, zirconium, silicon, copper, tin, iron and palladium. Due to the high volume of the core portion, the process of making the wire is less complex.

### TECHNICAL FIELD

The invention relates to a deposition wire of the powder-in-tube type, to a method of making such a deposition wire and to a particular use of such a deposition wire.

### Background Art

Additive manufacturing consists in making pieces by adding controlled layers of a material, in contrast to machining where material is removed.

For instance, 3D printing is possible using welding wires of titanium or titanium alloy.

Welding wires of titanium or of a titanium alloy are well known in the art because of the advantageous properties of titanium, namely a high strength to weight ratio (as strong as steel but half its weight), an excellent corrosion resistance and good mechanical properties at elevated temperatures.

U.S. Pat. No. 4,331,857 discloses a welding wire comprising a hollow tubular portion of titanium and a core portion filling the tubular portion. The core portion is formed from compacted alloying powders.

Usual welding techniques such as TIG welding require working under protective atmosphere and/or the use of active agent (flux) to improve the quality of the weld.

CN107363433 discloses a titanium-based alloy flux-cored welding wire comprising a metal sheath and an internal active drug core. The welding wire is composed of an outer skin and an internal active welding agent core. The metal sheath is a titanium strip with a titanium content of not less than 98% and a hydrogen content of not more than 0.015%. The internal active drug core consists of Metal powder, B powder, Si powder and active agent, wherein the metal powder comprises Ti, Co, Mn, Ni and Cu, the active agent comprises chloride, fluoroaluminate, MgF2 and SrF2, Powder, B powder, Si powder and active components by mass percentage: Ti is 16%-34%, Co is 0.2%-0.4%, Mn is 0.8%-1%, Ni is 1%-3%, Cu B is 2% to 6%, Si is 0.10% to 0.25%, chloride is 1% to 5%, fluoroaluminate is 12% to 16%, and MgF2 is 5% to 15%; SrF2 is 20%˜60%.

With the evolution of deposition techniques for additive manufacturing, the development of new types of deposition wires has become necessary because of the more stringent requirements in terms of accuracy and deposition rate. For metal additive manufacturing recent techniques consist in direct energy deposition (DED). Energy sources may include laser, electron beam, MIG/MAG Arc or plasma arc. Powder deposition by means of e.g. selective laser melting (SLM) or laser cladding powder is slow compared to wire-based DED. Therefore new deposition wires are being developed.

CN108000004 discloses a method for preparing a titanium flux cored wire for a 3D printing titanium matrix composite material.

Welding wires or deposition wires of titanium or of a titanium alloy, remain expensive and complex to manufacture. This is due to the many diameter reduction steps and the many intermediate heat treatments.

### DISCLOSURE OF INVENTION

It is a general object of the invention to avoid or at least to mitigate the disadvantages of the prior art.

It is a particular object of the invention to provide a deposition wire that is less complex to make and compatible with the most recent deposition techniques.

It is another object of the invention to reduce the number of steps needed to make a deposition wire.

According to a first aspect of the invention, there is provided a deposition wire of the powder-in-tube type. The deposition wire comprises a hollow tubular portion of titanium and a core portion filling the tubular portion. The core portion occupies between 25 volume % and 85 volume % of the complete deposition wire, e.g. between 27 volume % and 80 volume %, e.g. between 30 volume % and 75 volume %. The core portion comprises compacted elongated powders of titanium and possibly also comprises other compacted powders selected from the group consisting of aluminium, vanadium, aluminium-vanadium, chromium, molybdenum, boron, niobium, tantalum nickel, zirconium, silicon, copper, tin, iron and palladium.

Aluminium-vanadium powders are preferred above vanadium powders as vanadium powders are very expensive.

Aluminium and vanadium (either vanadium as such or as aluminium-vanadium) are the most preferred elements to be used in deposition wires for aviation. Chromium and molybdenum are also preferred for deposition wires for aviation.

Boron is a very interesting element for its grain refining properties. Boron is a nano size grain refinement element. Boron powder has an acidic oxide (B₂O₃) layer around its surface and this layer absorbs some moisture. As metal oxides are generally basic, the surfaces of boron and of the metal powders can attach together.

As the quantity of boron is very low, boron can also be mixed in a solution and then sprayed onto dry mixing powders. After mixing, the powders can be dried in an oven.

Alternatively, all the powders can be mixed in a solvent and fed into a U-profile in a slurry.

Preferably the core portion occupies more than 40 volume %, e.g. more than 50 volume % of the complete deposition wire.

The deposition wire may have a butt welded seam or a laser welded seam. The most preferable embodiment, however, is a cold welded overlap seam.

The advantageous effect of the invention is as follows. In comparison with the welding wire of U.S. Pat. No. 4,331,857, the volume portion of powder material is much greater. This means that the energy needed to reduce the diameter of the deposition wire until its final value, is much less. The titanium powder inside the core is the major contributor for improved processability. The titanium powders will elongate during diameter reduction and will provide continuous powder flow and will minimize the powder locking. Hence, less reduction steps in the form of drawing steps or rolling steps are needed. And, as less reduction steps are needed, there is less or even no need for intermediate heat treatments. The higher volume portion of powder material may be at the detriment of the tensile strength level, but the tensile strengths reached with the deposition wires of the invention are largely sufficient for use as deposition wire. Moreover, as will be explained more in detail hereinafter, the final tensile strength of the deposition wire depends upon the degree of reduction, upon whether the last process step is a heat treatment or not, and upon the initial tensile strength of the tube portion.

The tubular portion must have a minimum volume percentage of 15% in order to enable the first reduction steps. If the minimum volume percentage of the tubular portion is lower than 15%, the strip forming the tubular portion risks to break.

The compacted elongated powders of titanium may originate from non-spherical sponge powders or may originate from spherical sponge powders. Non-spherical sponge powders of titanium are much cheaper than spherical powders of titanium. The spherical titanium powders may be plasma atomized powders. In one embodiment, the compacted elongated powders of titanium originate all from non-spherical sponge powders. In another embodiment, the compacted elongated powders of titanium originate all from spherical sponge powders. Non-spherical powders result in a more capricious grain structure than spherical powders.

In a preferable embodiment, the compacted elongated powders of titanium at least partially originate from non-spherical sponge powders of titanium and partially from spherical sponge powders. This means that the titanium powders that are initially put on a strip of titanium for making the deposition wire are a mix of spherical powders of titanium and non-spherical sponge powders of titanium.

The compacted elongated powders of titanium may also originate from recycled powders or swarf, contributing to the circular economy. In one embodiment, the compacted elongated powders of titanium originate all from recycled powders or swarf. In another embodiment, the compacted elongated powders of titanium originate from both recycled powders and non-recycled spherical sponge powders. Recycled powders and swarf 10 result also in a more capricious grain structure than spherical powders.

Surprisingly, the final properties of the deposition wire of the present invention were found to be also dependent from the type of powder material used, and the mixing thereof. Both higher tensile strength and elongation were obtained in deposition wires with non spherical sponge titanium powders compared to spherical titanium powders.

Preferably the powders of titanium have more than 65% of the volume of the core portion. More preferably more than 80% of the volume of the core portion consists of titanium powders.

In one embodiment, there are no compacted other powders present in the core portion, i.e. all the powders present in the core portion are of titanium. This results in a deposition wire of titanium only and unavoidable impurities.

Preferably and in general, the deposition wire comprises not more than 0.15% by weight of carbon, e.g. not more than 0.10% by weight.

Most preferably and in general, the deposition wire comprises not more than 1.0% by weight of oxygen, e.g. not more than 0.50% by weight, e.g. not more than 0.20% by weight.

Titanium wires follow stringent specification limits, in particular with regard to impurities, such as C, O, H, N. Especially the Oxygen content in the deposition wire is important, since it influences the deposition process adversely by leaving a Ti oxide layer on a newly deposited layer in welding or additive manufacturing, which requires machining of the newly deposited layer, before depositing the subsequent layer, leading to extra costs and sources of defects in a weld bead or additively manufactured part. According to ASTM, specification limits for O are 0.18% by weight for Grade 1 and 0.40% by weight for Grade 4.

The volume fraction of non-spherical sponge powders of titanium, or recycled powders and swarf needs therefore to be balanced and adjusted with either the Ti strip material or the spherical powders of titanium to prevent too much oxygen to be trapped during the wire making process.

Due to the diameter reduction, the powder material of the core portion gets compacted and elongated. The size of the voids between the compacted and elongated powders are reduced to a minimum. These voids only appear occasionally.

The deposition wire according to the first aspect of the invention has a final diameter, i.e. the outer diameter of the tubular portion after reduction, of less than 6.0 mm, e.g. of less than 5.0 mm, e.g. of less than 4.0 mm, e.g. of less than 3.6 mm, e.g. of less than 2.5 mm. Typical diameter ranges are from 1.0 mm to 1.6 mm for automated wire feeding in automated processes such as MIG welding and for arc-based (plasma, laser) additive manufacturing (3D printing). Diameter ranges above 2.0 mm are used in manual feeding of the wire, such as in TIG welding. Even larger diameter ranges e.g. above 2.5 mm or above 3.6 mm are used in electron-beam or laser additive manufacturing (3D printing), or other processes which target very high deposition rates.

According to a second aspect of the invention, there is provided a method of making a deposition wire of the powder-in-tube type. The method comprising the following steps:
a) providing a strip of titanium;
b) providing powders of titanium and possibly other powders selected of the group consisting of aluminium, vanadium, chromium, molybdenum, boron, niobium and tantalum;
c) putting said powders of titanium and said other powders on the strip;
d) closing the strip to form a tube around a core portion of the powders of titanium and the other powders, said core portion occupying between 30 volume % and 80 volume % of said tube and said core portion;
e) reducing the diameter of the tube by rolling or drawing in various rolling or drawing steps.

In an embodiment, one or more intermediate heat treatments are applied between the various subsequent rolling or drawing steps.

In another embodiment, no such intermediate heat treatment is needed.

In order to avoid oxidation, at least steps c) to d) preferably occur in an inert atmosphere.

In a highly preferable embodiment of step d), the closing of the strip comprises creating an overlap of the strip. The overlap of the strip is cold welded during the diameter reduction. This way of working allows to create a seamless cored wire and, above all, avoids hot welding and substantially reduces the risk of titanium powder fire.

### BRIEF DESCRIPTION OF FIGURES IN THE DRAWINGS

FIG. 1a, FIG. 1b, FIG. 1c and FIG. 1d illustrate the subsequent steps of manufacturing a deposition wire of the powder-in-tube type according to the invention.

FIG. 2 shows a cross-section of a final deposition wire of the powder-in-tube type according to the invention.

FIG. 3 shows a cross-section of another final deposition wire of the powder-in-tube type according to the invention.

### MODE(S) FOR CARRYING OUT THE INVENTION

A titanium deposition wire of the powder-in-tube type is made as follows.

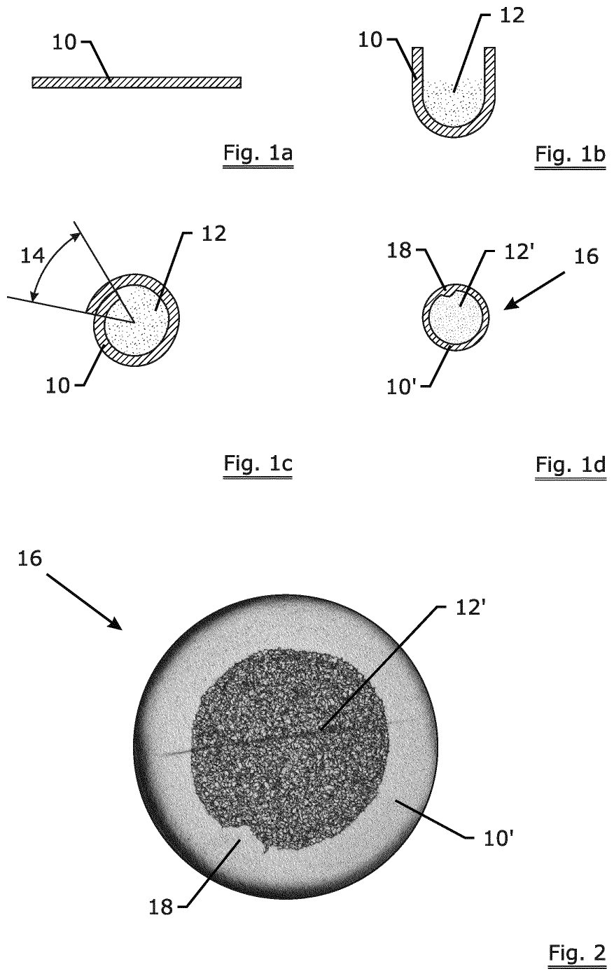

Referring to FIG. 1a, starting product is a titanium strip 10 with a thickness of e.g. 0.7 mm.

FIG. 1b illustrates a second step where titanium strip 10 is deformed in a U-form. Titanium powder, aluminium powder and aluminium-vanadium powder, all referred to be reference number 12, will be put on the deformed strip 10. For a wire weight of 100 kg, about 30 kg Ti powder is needed, about 6.4 kg of Al—V powder and an additional amount of Al powder of about 3.8 kg.

FIG. 1c illustrates a third step. The strip 10 with the powder 12 will be closed thereby creating an overlap 14 of between 60° and 90°. The external diameter of the closed strip is 6.0 mm.

The closed strip is then subjected to various reduction steps until it a final external diameter of 1.30 mm. A cross-section of the final deposition wire 16 of the powder-in-tube type is shown in FIG. 1d. Due to the various reduction steps, the powders 12 have been elongated and have become fibres 12′. The strip 10′ has been reduced in thickness. The strip 10′ may show a local thickness 18, which is a consequence of the welding of the tube.

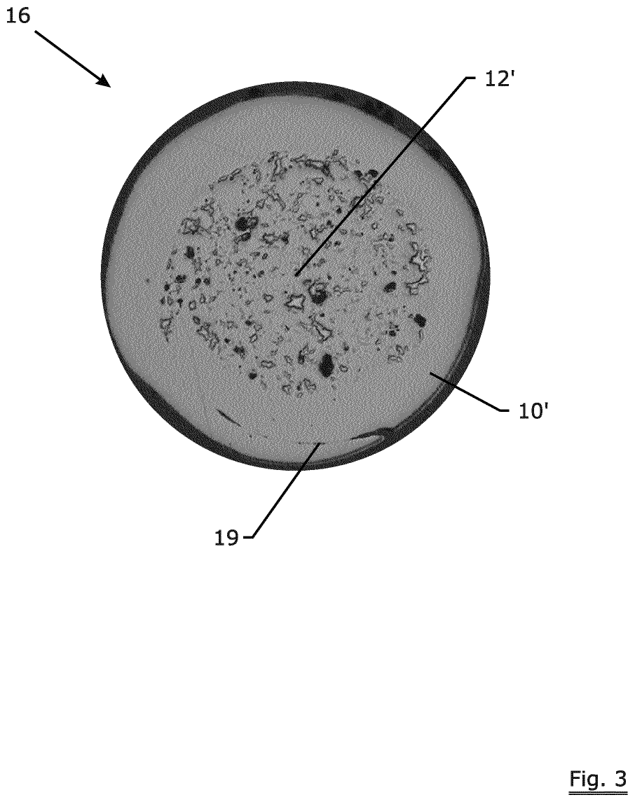

FIG. 2 shows a view by optical microscopy of a cross-section of a final deposition wire 16 of the powder-in-tube type. The external diameter is 1.27 mm. The average thickness of the strip is 0.225 mm. The ratio of core volume vs total volume is 41.6%. One can make a clear distinction between the core portion 12′ with elongated powders and the deformed strip portion 10′.

FIG. 3 shows also a view by optical microscopy of a cross-section of a preferable embodiment of a deposition wire 16 of the powder-in-tube type. The difference with the embodiment of FIG. 2 is that a cold welded overlap seam was used in the preferable embodiment of FIG. 3 for closing the tube. Traces of this overlap can be seen at the bottom of the FIG. 3 and are pointed by arrow 19.

### Test Results

Tensile tests were carried on three different titanium deposition wires:
1) A Ceweld ER Ti-1 commercially available welding wire of 100% titanium and with a final diameter of 1.199 mm;
2) a deposition wire according to the invention with a core volume portion of 44.5% and where the core was initially filled with non-spherical sponge titanium powder, final diameter is 1.261 mm;
3) a deposition wire according to the invention with a core volume portion of 52.8% and where the core was initially filled with spherical titanium powder, final diameter is 1.273 mm.

### Strength and Force Values

| | E | | | | | |
|---|---|---|---|---|---|---|
| | modulus | R_{p0.05} | R_{p0.2} | Rₘ | R_{p0.2}/Rₘ | Fₘ |
| Sample | (MPa) | (Mpa) | (Mpa) | (Mpa) | (%) | (N) |
| 1 REF | 95998.7 | 333.76 | 378.90 | 465.91 | 81.3 | 526.1 |
| 1 REF | 97387.6 | 304.77 | 354.03 | 429.43 | 82.4 | 484.9 |
| 1 REF | 99852.9 | 309.76 | 357.26 | 429.09 | 83.3 | 484.5 |
| 2 INV | 82917.6 | 781.64 | 935.55 | 1038.70 | 90.1 | 1297.0 |
| 2 INV | 91314.5 | 711.77 | 913.27 | 1036.60 | 88.1 | 1295.0 |
| 2 INV | 90788.1 | 727.10 | 922.40 | 1040.90 | 88.6 | 1300.0 |
| 3 INV | 86662.6 | 700.01 | — | 754.00 | — | 959.7 |
| 3 INV | 83913.9 | 708.43 | — | 734.66 | — | 935.0 |
| 3 INV | 84231.0 | 726.49 | — | 752.59 | — | 957.9 |

E-modulus is the modulus of elasticity.

R_{p0.05} is the yield strength at 0.05% permanent elongation.

R_{p0.2} is the yield strength at 0.20% permanent elongation.

Rₘ is the tensile strength.

Fₘ is the maximum load.

### Elongation Values

| Sample | A (%) | Aₜ (%) | A_{g} (%) | A_{gt} (%) |
|---|---|---|---|---|
| 1 REF | 17.71 | 15.12 | 7.688 | 8.174 |
| 1 REF | 12.93 | 13.27 | 7.088 | 7.529 |
| 1 REF | 7.963 | 8.307 | 6.263 | 6.692 |
| 2 INV | 4.039 | 5.223 | 1.833 | 3.085 |
| 2 INV | 3.606 | 4.705 | 1.834 | 2.970 |
| 2 INV | 3.786 | 4.896 | 1.758 | 2.904 |
| 3 INV | 0.1074 | 0.9526 | 0.0800 | 0.9500 |
| 3 INV | 0.0705 | 0.9460 | 0.0705 | 0.9460 |
| 3 INV | 0.0901 | 0.9639 | 0.0667 | 0.9602 |

A is the percentage elongation after fracture.

Aₜ is the percentage total elongation at fracture.

A_{g} is the permanent elongation at maximum load.

Despite the fact that in the invention deposition wires there is a core portion initially filled with powders, the strength and load values of the invention deposition wires are significantly higher than those of the prior art welding wire. This is mainly due to the fact that the prior art welding wire has been subjected to a final heat treatment, while the invention deposition wires were end cold deformed, without a final heat treatment. When comparing the two invention deposition wires, sample INV 2 with the non-spherical sponge titanium powders, has the highest strength and force values. Sample INV 3 with the spherical titanium powders has the lowest elongation values.

Additionally, sample INV 2 has higher total elongation than sample INV3 despite the fact that it has been cold deformed.

By mixing both non-spherical sponge titanium powders with spherical titanium powders in varying proportions, one may determine—within certain limits—either the desired strength or the desired elongation.

For example by mixing 50% of non spherical sponge titanium powders with 50% spherical titanium powders, a deposition wire of 1.25 mm diameter having at least 2% total elongation and at least 800 MPa tensile strength can be obtained.

### Impurity Limits

The upper limits on the C, O and H concentrations (in weight %) are set in the ASTM standard for pure titanium and titanium alloy. They are reported in the table below for pure titanium grade 1 to grade 4 and titanium alloy grade 5.

| Unalloyed grade | Max. C % | Max. O % | Max. H % |
|---|---|---|---|
| ASTM grade 1 | 0.08 | 0.18 | 0.015 |
| ASTM grade 2 | 0.08 | 0.25 | 0.015 |
| ASTM grade 3 | 0.08 | 0.35 | 0.015 |
| ASTM grade 4 | 0.08 | 0.40 | 0.015 |
| ASTM grade 5 | 0.08 | 0.20 | 0.015 |

The contents of C, O and H were measured via combustion analysis (LECO) in the 3 samples and are reported in the table below.

| | C % | C % | O % | O % | H % | H % |
|---|---|---|---|---|---|---|
| Sample | Average | StDev | Average | StDev | Average | StDev |
| 1 REF | 0.0109 | 0.0010 | 0.1010 | 0.0025 | 0.0056 | 0.0003 |
| 2 INV | 0.0176 | 0.0057 | 0.1450 | 0.0189 | 0.0088 | 0.0022 |
| 3 INV | 0.0190 | 0.0051 | 0.1430 | 0.0044 | 0.0075 | 0.0001 |

In all three samples, including in sample 2 INV containing mixed spherical titanium powders and non-spherical sponge titanium powders, all measured values are below the upper limits recommended by ASTM for different Ti grades.

### LIST OF REFERENCE NUMBERS

10 Titanium strip
10′ Titanium strip after reduction in cross-section
12 Titanium powder and other added powders
12′ Elongated titanium and other powders after reduction in cross-section
14 Overlap
16 Final deposition wire
18 Thickness in titanium strip due to welding
19 Traces in the cross-section due to welding overlap

1. A deposition wire of the powder-in-tube type,
said deposition wire comprising a hollow tubular portion of titanium and a core portion filling the tubular portion,
said core portion occupying between 25 volume % and 85 volume % of said deposition wire, said core portion comprising compacted elongated powders of titanium and possibly comprising other compacted powders selected from the group consisting of aluminium, vanadium, aluminium-vanadium, chromium, molybdenum, boron, niobium, tantalum, nickel, zirconium, silicon, copper, tin, iron and palladium.

2. The deposition wire of claim 1,
said core portion occupying more than 40 volume % of said deposition wire; preferably more than 42 volume %.

3. The deposition wire of claim 1,
said deposition wire having a cold welded overlap seam, a butt welded seam or a laser welded seam.

4. The welding deposition wire according to claim 1,
wherein said compacted elongated powders of titanium at least partially originate from non-spherical sponge powders of titanium.

5. The deposition wire according to claim 1,
wherein said compacted elongated powders of titanium at least partially originate from recycled powders of titanium or swarf.

6. The deposition wire according to claim 1,
wherein said powders of titanium have more than 65 volume % of the core portion.

7. The deposition wire of claim 6,
wherein there are no other compacted powders present in the core portion.

8. The deposition wire according to claim 1,
wherein said deposition wire comprises no more than 0.15% by weight of carbon.

9. The deposition wire according to claim 1,
wherein said deposition wire comprises no more than 1.0% by weight of oxygen.

10. The deposition wire according to claim 1,
wherein the deposition wire has a final diameter (i.e. outer diameter of the tubular portion) of less than 6.0 mm.

11. The deposition wire according to claim 4,
wherein both the tensile strength and the total elongation obtained are higher than in a deposition wire wherein said compacted elongated powders of titanium only originate from spherical sponge powders of titanium.

12. A method of making a deposition wire of the powder-in-tube type, said method comprising the following steps:
a) providing a strip of titanium;
b) providing powders of titanium and possibly other powders selected of the group consisting of aluminium, vanadium, chromium, molybdenum, boron, niobium and tantalum;
c) putting said powders of titanium and said other powders on the strip;
d) closing the strip to form a tube around a core portion of the powders of titanium and the other powders, said core portion occupying between 30 volume % and 80 volume % of said tube and said core portion;
e) reducing the diameter of the tube by rolling or drawing in various rolling or drawing steps.

13. The method of making a deposition wire according to claim 12,
wherein one or more intermediate heat treatments are applied between said rolling or drawing steps.

14. The method of making a deposition wire according to claim 12,
wherein at least steps c) to d) occur in an inert atmosphere.

15. The method of making a deposition wire according to claim 12, wherein step d) of closing the strip comprises creating an overlap of the strip.

16. The method of making a deposition wire according to claim 12,
wherein said compacted elongated powders of titanium at least partially originate from non-spherical sponge powders of titanium.

17. The method of making a deposition wire according to claim 12,
wherein said compacted elongated powders of titanium at least partially originate from recycled powders of titanium or swarf.
